(19) United States
(12) Patent Application Publication
(10) Pub. No.: US 2012/0120229 A1
(43) Pub. Date: May 17, 2012

(54) CIGARETTE PACKAGE INSPECTION SYSTEM, AND ASSOCIATED METHOD

(75) Inventors: Franklin Forrest Brantley, Winston-Salem, NC (US); Darrell Thomas Dixon, Clemmons, NC (US); Larry Dean McCann, King, NC (US); Eddie Lee Nuckols, Mocksville, NC (US)

(73) Assignee: RJ Reynolds Tobacco Company

(21) Appl. No.: 12/947,018

(22) Filed: Nov. 16, 2010

(51) Int. Cl. H04N 7/18; G06K 9/00

(52) U.S. Cl. 348/92; 382/143; 348/E07.085

(57) ABSTRACT

An inspection system and associated method are provided for inspecting a cigarette package. A transport device is configured to transport individual cigarette packages to an inspection position such that at least a portion of the cigarette package is visibly accessible for optical inspection. An inspection device is configured to optically inspect each cigarette package, at least about the visibly accessible portion thereof, as the cigarette package is transported through the inspection position, and to automatically determine from the optical inspection whether the inspected cigarette package is defective.

### BACKGROUND OF THE DISCLOSURE

1. Field of the Disclosure

Aspects of the present disclosure relate to cigarette packaging and, more particularly, to a cigarette package inspection system and associated method.

2. Description of Related Art

Popular smoking articles, such as cigarettes, have a substantially cylindrical rod shaped structure and include a charge, roll, or column of smokable material such as shredded tobacco (e.g., in cut filler form) surrounded by a paper wrapper thereby forming a so-called “smokable rod” or “tobacco rod.” Normally, a cigarette has a cylindrical filter element aligned in an end-to-end relationship with the tobacco rod. Typically, a filter element comprises cellulose acetate tow plasticized using triacetin, and the tow is circumscribed by a paper material known as “plug wrap.” A cigarette can incorporate a filter element having multiple segments, and one of those segments can comprise activated charcoal particles. See, for example, U.S. Pat. No. 6,537,186 to Veluz; PCT Publication No. WO 2006/064371 to Banerjea; and U.S. patent application Ser. No. 11/226,932, filed Sep. 14, 2005, to Coleman III, et al.; each of which is incorporated herein by reference. Typically, the filter element is attached to one end of the tobacco rod using a circumscribing wrapping material known as “tipping paper,” in order to provide a so-called “filtered cigarette.” It also has become desirable to perforate the tipping material and plug wrap, in order to provide dilution of drawn mainstream smoke with ambient air. Descriptions of cigarettes and the various components thereof are set forth Tobacco Production, Chemistry and Technology, Davis et al. (Eds.) (1999). A cigarette is employed by a smoker by lighting one end thereof and burning the tobacco rod. The smoker then receives mainstream smoke into his/her mouth by drawing on the opposite end (e.g., the filter or mouth end) of the cigarette.

In any instance, as-formed cigarettes may be typically provided to a cigarette packaging device, where the as-formed cigarettes are loaded into a package or otherwise suitable container. In this regard, manufacturing and packaging of relatively small quantities, lots, or batches of finished cigarettes having consistent quality can be provided in an automated fashion. Representative cigarette packages are of the types that traditionally have been employed for the commercial distribution and sale of smoking articles, such as cigarettes. See also, for example, the types of cigarette package configurations and packaging materials set forth in U.S. Pat. No. 4,294,353 to Focke et al.; U.S. Pat. No. 4,534,463 to Bouchard; U.S. Pat. No. 4,715,497 to Focke et al.; U.S. Pat. No. 4,852,734 to Allen et al.; U.S. Pat. No. 5,139,140 to Burrows et al.; U.S. Pat. No. 5,333,729 to Wolfe; U.S. Pat. No. 5,938,018 to Keaveney et al.; U.S. Pat. No. 6,726,006 to Funderburk et al.; U.S. Pat. No. 6,736,261 to Thomas et al. and U.S. Pat. No. 7,325,382 to Nelson et al.; PCT WO 2005/113386 to Buse; UK Pat. Spec. 1,042,000; German Pat. App. DE 10238906 to Marx; and US Pat. Applic. Nos. 2004/0217023 to Fagg et al.; 2004/0256253 to Henson et al.; 2005/0150786 to Mitten et al.; 2006/0243611 to Wu; 2008/0093234 to Jones et al. and 2008/0099353 to Parsons et al. Such packaging may typically include indicia thereon for providing information related to the cigarette brand, manufacturer, etc. Typically, each cigarette package may include a date code label consisting of alphanumeric characters and indicative of at least the date and location in which the respective cigarette package was filled with as-finished cigarettes. Such date code labels are used for tracking purposes such that each cigarette package can be traced to its packaging date and origin.

However, in the imprinting of the date code labels, the procedure for imprinting on the cigarette package may result in certain undesirable defects which leave the date code label illegible. For example, the date code label may be partially or entirely missing from the cigarette package, the date code label may be compressed or otherwise smudged such that the date code label is rendered illegible, and the date code label may include some other characteristic(s) affecting the readability thereof.

It follows that, due to the high speed nature of the cigarette packaging imprinting process, many of the date code label defects that may occur during the imprinting process may not be readily apparent or otherwise detected before the packages are shipped for sale. As such, there exists a need for a method and system for inspecting individual cigarette packages for defects prior to the packages being distributed and sold. In some instances, such an apparatus and method may desirably be used to halt or pause the production process upon detection of certain defects, amount of defects, and/or frequency of defects, such that the cause of the defects can be expediently addressed. It may also be desirable for such a solution to be readily implemented with respect to existing cigarette production machinery.

### BRIEF SUMMARY OF THE DISCLOSURE

The above and other needs are met by aspects of the present disclosure which, in one aspect, provides a cigarette package inspection system. Such an inspection system comprises a transport device configured to transport individual cigarette packages to an inspection position such that at least a portion of the cigarette package is visibly accessible for optical inspection. An inspection device is operably engaged with the transport device and is configured to optically inspect each cigarette package, at least about the visibly accessible portion thereof, as the cigarette package is transported through the inspection position. The inspection device is configured to automatically determine from the optical inspection whether the inspected cigarette package is defective.

In order to accomplish the optical inspection, an imaging device may be configured to capture at least one image of each cigarette package, at least about the accessible portion of the cigarette package, as the cigarette package is transported through the inspection position. In some instances, a display terminal may be operably engaged with the imaging device and configured to display the at least one image of each cigarette package. In other instances, the inspection device may further comprise a computer device configured to automatically process the at least one image from the imaging device to determine whether the inspected cigarette package is defective.

According to another aspect a selection device may be operably engaged with the transport device, with the selection device being responsive to the inspection device to remove any cigarette package determined to be defective by the inspection device. In this regard, the inspection device may be further configured to determine whether a code label defect exists in a code label imprinted on the cigarette package from the optical inspection thereof, the code label comprising at least one alphanumeric character selectively imprinted on the cigarette package, the code label defect being determined according to whether the code label is at least partially missing, whether the code label is visibly legible, whether the code label is missing a character, and whether the code label includes a characteristic affecting the readability thereof.

According to yet another aspect, the inspection device may be configured to determine, from the optical inspection of each cigarette package, whether the cigarette package corresponds to a non-defective cigarette package. In such instances, for example, any cigarette package not corresponding to a non-defective cigarette package, through the optical inspection, may be determined to be defective.

Yet another aspect of the present disclosure comprises a method of inspecting a cigarette package. Such a method comprises transporting individual cigarette packages to an inspection position with a transport device such that at least a portion of the cigarette package is visibly accessible for optical inspection. Each cigarette package is then optically inspected with an inspection device, at least about the visibly accessible portion of the cigarette package, as the cigarette package is transported through the inspection position, and the inspection device is configured to automatically determine whether the inspected cigarette package is defective from the optical inspection thereof.

In one aspect, such a method may further comprise displaying the at least one image of each cigarette package on a display terminal operably engaged with the imaging device. In another aspect, such a method may further comprise automatically processing at least one image from the imaging device with a computer device to determine whether the inspected cigarette package is defective. In still another aspect, any cigarette package determined to be defective may be removed with a selection device operably engaged with the transport device, in response to the determination by the inspection device. In this regard, determining whether a defect exists in the cigarette packages from the optical inspection thereof may be determined according to, for example, whether the code label is at least partially missing, whether the code label is visibly legible, whether the code label is missing a character, and whether the code label includes a characteristic affecting the readability thereof.

In yet another aspect, such a method may further comprise determining, from the optical inspection of each cigarette package, whether the cigarette package corresponds to a non-defective cigarette package. In such instances, for example, any cigarette package not determined to correspond to a non-defective cigarette package, through the optical inspection, may thus be determined to be defective.

Aspects of the present disclosure are thus capable of inspecting individual cigarette packages for defects prior to the packages being distributed and sold. In some instances, aspects of the present disclosure may also be used to halt or pause the production process upon detection of certain defects, amount of defects, and/or frequency of defects, such that the cause of the defects can be expediently addressed. Aspects of the present disclosure may also be readily implemented with respect to existing cigarette production machinery. Aspects of the present disclosure thus address the above needs and provide these and other advantages as otherwise detailed herein.

### BRIEF DESCRIPTION OF THE SEVERAL VIEWS OF THE DRAWINGS

Having thus described the present disclosure in general terms, reference will now be made to the accompanying drawings, which are not necessarily drawn to scale, and wherein:

FIG. 1 is a schematic perspective view of an exemplary cigarette package capable of being inspected in accordance with various aspects of the present disclosure;

FIG. 2 is a perspective side elevation of a cigarette package inspection system for inspecting a cigarette package, according to one aspect of the disclosure;

FIG. 3 is a plan view of the cigarette package inspection system of FIG. 2;

FIG. 4 is a perspective view of a selection device for a cigarette package inspection system, according to one aspect of the present disclosure;

FIG. 5 is a perspective side elevation of a cigarette package inspection system including a chute for directing defective cigarette packages into a collection bin, according to one aspect of the disclosure;

FIG. 6 is a schematic view of components of an inspection device associated with a cigarette package inspection system for inspecting a cigarette package, according to one aspect of the disclosure;

FIG. 7 illustrates a display terminal of a cigarette package inspection system, the display terminal being used to display an image of each cigarette package transported through the inspection system, according to one aspect of the disclosure; and

FIGS. 8-16 illustrate cigarette package images displayed on a display terminal of a cigarette package inspection system, the cigarette package images providing examples of defective cigarette packages, according to various aspects of the present disclosure.

### DETAILED DESCRIPTION OF THE DISCLOSURE

The present disclosure now will be described more fully hereinafter with reference to the accompanying drawings, in which some, but not all aspects of the disclosure are shown. Indeed, this disclosure may be embodied in many different forms and should not be construed as limited to the aspects set forth herein; rather, these aspects are provided so that this disclosure will satisfy applicable legal requirements. Like numbers refer to like elements throughout.

Cigarette rods may be manufactured using a cigarette making machine, such as a conventional automated cigarette rod making machine. Exemplary cigarette rod making machines are of the type commercially available from Molins PLC or Hauni-Werke Korber & Co. KG. For example, cigarette rod making machines of the type known as MkX (commercially available from Molins PLC) or PROTOS (commercially available from Hauni-Werke Korber & Co. KG) can be employed. A description of a PROTOS cigarette making machine is provided in U.S. Pat. No. 4,474,190 to Brand, at col. 5, line 48 through col. 8, line 3, which is incorporated herein by reference. Types of equipment suitable for the manufacture of cigarettes also are set forth in U.S. Pat. No. 4,781,203 to La Hue; U.S. Pat. No. 4,844,100 to Holznagel; U.S. Pat. No. 5,156,169 to Holmes et al.; U.S. Pat. No. 5,191,906 to Myracle, Jr. et al.; U.S. Pat. No. 6,647,878 to Blau et al.; U.S. Pat. No. 6,848,449 to Kitao et al.; and U.S. Pat. No. 6,904,917 to Kitao et al.; and U.S. Patent Application Publication Nos. 2003/0145866 to Hartman; 2004/0129281 to Hancock et al.; 2005/0039764 to Barnes et al.; and 2005/0076929 to Fitzgerald et al.; each of which is incorporated herein by reference.

The components and operation of conventional automated cigarette making machines will be readily apparent to those skilled in the art of cigarette making machinery design and operation. For example, descriptions of the components and operation of several types of chimneys, tobacco filler supply equipment, suction conveyor systems and garniture systems are set forth in U.S. Pat. No. 3,288,147 to Molins et al.; U.S. Pat. No. 3,915,176 to Heitmann et al; U.S. Pat. No. 4,291,713 to Frank; U.S. Pat. No. 4,574,816 to Rudszinat; U.S. Pat. No. 4,736,754 to Heitmann et al. U.S. Pat. No. 4,878,506 to Pinck et al.; U.S. Pat. No. 5,060,665 to Heitmann; U.S. Pat. No. 5,012,823 to Keritsis et al. and U.S. Pat. No. 6,360,751 to Fagg et al.; and U.S. Patent Application Publication No. 2003/0136419 to Muller; each of which is incorporated herein by reference. The automated cigarette making machines of the type set forth herein provide a formed continuous cigarette rod or smokable rod that can be subdivided into formed smokable rods of desired lengths.

Various types of cigarette components, including tobacco types, tobacco blends, top dressing and casing materials, blend packing densities and types of paper wrapping materials for tobacco rods, can be employed. See, for example, the various representative types of cigarette components, as well as the various cigarette designs, formats, configurations and characteristics, that are set forth in Johnson, Development of Cigarette Components to Meet Industry Needs, 52^{nd} T.S.R.C. (September, 1998); U.S. Pat. No. 5,101,839 to Jakob et al.; U.S. Pat. No. 5,159,944 to Arzonico et al.; U.S. Pat. No. 5,220,930 to Gentry and U.S. Pat. No. 6,779,530 to Kraker; U.S. Patent Publication Nos. 2005/0016556 to Ashcraft et al. and 2005/0066986 to Nestor et al.; and U.S. patent application Ser. No. 11/375,700, filed Mar. 14, 2006, to Thomas et al. and Ser. No. 11/408,625, filed Apr. 21, 2006, to Oglesby; each of which is incorporated herein by reference. Most preferably, the entire smokable rod is composed of smokable material (e.g., tobacco cut filler) and a layer of circumscribing outer wrapping material.

Components for filter elements for filtered cigarettes typically are provided from filter rods that are produced using traditional types of rod-forming units, such as those available as KDF-2 and KDF-3E from Hauni-Werke Korber & Co. KG. Typically, filter material, such as filter tow, is provided using a tow processing unit. An exemplary tow processing unit has been commercially available as E-60 supplied by Arjay Equipment Corp., Winston-Salem, N.C. Other exemplary tow processing units have been commercially available as AF-2, AF-3, and AF-4 from Hauni-Werke Korber & Co. KG. In addition, representative manners and methods for operating a filter material supply units and filter-making units are set forth in U.S. Pat. No. 4,281,671 to Byrne; U.S. Pat. No. 4,862,905 to Green, Jr. et al.; U.S. Pat. No. 5,060,664 to Siems et al.; U.S. Pat. No. 5,387,285 to Rivers; and U.S. Pat. No. 7,074,170 to Lanier, Jr. et al. Other types of technologies for supplying filter materials to a filter rod-forming unit are set forth in U.S. Pat. No. 4,807,809 to Pryor et al. and U.S. Pat. No. 5,025,814 to Raker; which are incorporated herein by reference.

The filter material can vary, and can be any material of the type that can be employed for providing a tobacco smoke filter for cigarettes. Preferably a traditional cigarette filter material is used, such as cellulose acetate tow, gathered cellulose acetate web, polypropylene tow, gathered cellulose acetate web, gathered paper, strands of reconstituted tobacco, or the like. Especially preferred is filamentary tow such as cellulose acetate, polyolefins such as polypropylene, or the like. One filter material that can provide a suitable filter rod is cellulose acetate tow having 3 denier per filament and 40,000 total denier. As another example, cellulose acetate tow having 3 denier per filament and 35,000 total denier can provide a suitable filter rod. As another example, cellulose acetate tow having 8 denier per filament and 40,000 total denier can provide a suitable filter rod. For further examples, see the types of filter materials set forth in U.S. Pat. No. 3,424,172 to Neurath; U.S. Pat. No. 4,811,745 to Cohen et al.; U.S. Pat. No. 4,925,602 to Hill et al.; U.S. Pat. No. 5,225,277 to Takegawa et al. and U.S. Pat. No. 5,271,419 to Arzonico et al.; each of which is incorporated herein by reference.

Normally a plasticizer such as triacetin is applied to the filamentary tow in traditional amounts using known techniques. Other suitable materials or additives used in connection with the construction of the filter element will be readily apparent to those skilled in the art of cigarette filter design and manufacture. See, for example, U.S. Pat. No. 5,387,285 to Rivers.

The plug wrap can vary. See, for example, U.S. Pat. No. 4,174,719 to Martin. Typically, the plug wrap is a porous or non-porous paper material. Suitable plug wrap materials are commercially available. Exemplary plug wrap papers ranging in porosity from about 1,100 CORESTA units to about 26,000 CORESTA units are available from Schweitzer-Maudit International as Porowrap 17-M1, 33-M1, 45-M1, 70-M9, 95-M9, 150-M4, 150-M9, 240M9S, 260-M4 and 260-M4T; and from Miquel-y-Costas as 22HP90 and 22HP150. Non-porous plug wrap materials typically exhibit porosities of less than about 40 CORESTA units, and often less than about 20 CORESTA units. Exemplary non-porous plug wrap papers are available from Olsany Facility (OP Paprina) of the Czech Republic as PW646; Wattenspapier of Austria as FY/33060; Miquel-y-Costas of Spain as 646; and Schweitzer-Mauduit International as MR650 and 180. Plug wrap paper can be coated, particularly on the surface that faces the filter material, with a layer of a film-forming material. Such a coating can be provided using a suitable polymeric film-forming agent (e.g., ethylcellulose, ethylcellulose mixed with calcium carbonate, nitrocellulose, nitrocellulose mixed with calcium carbonate, or a so-called lip release coating composition of the type commonly employed for cigarette manufacture). Alternatively, a plastic film (e.g., a polypropylene film) can be used as a plug wrap material. For example, non-porous polypropylene materials that are available as ZNA-20 and ZNA-25 from Treofan Germany GmbH & Co. KG can be employed as plug wrap materials.

Manners and methods for applying adhesives to tipping materials during automated cigarette manufacture will be apparent to those skilled in the art of cigarette design and manufacture. For example, a filtered cigarette can be tipped with a first layer of tipping material in an essentially traditional manner using a Lab MAX tipping device that is available from Hauni-Werke Korber & Co. KG, and that tipped cigarette can be collected and tipped again using that device (e.g., using the device in an essentially traditional manner, or in a suitably modified manner to provide a desired pattern of adhesive application) in order to provide a filtered cigarette possessing two layers of tipping material.

The tipping material that is used for any of the tipping material layers can vary. In certain preferred aspects, the material used to construct both tipping material layers has the characteristics and qualities commonly associated with cigarette tipping materials known in the art. As such, both layers can be constructed of the types of material conventionally used as tipping material in the manufacture of cigarettes. Typical tipping materials are papers exhibiting relatively high opacities. Representative tipping materials have TAPPI opacities of greater than about 81 percent, often in the range of about 84 percent to about 90 percent, and sometimes greater than about 90 percent. Typical tipping materials are printed with inks, typically nitrocellulose based, which can provide for a wide variety of appearances and “lip release” properties. Representative tipping papers materials have basis weights ranging from about 25 m/m² to about 60 g/m², often about 30 g/m² to about 40 g/m². Representative tipping papers are available as Tervakoski Reference Nos. 3121, 3124, TK 652, TK674, TK675, A360 and A362; and Schweitzer-Mauduit International Reference Nos. GSR270 and GSR265M2. See also, for example, the types of tipping materials, the methods for combining cigarette components using tipping materials, and techniques for wrapping various portions of cigarettes using tipping materials, that are set forth in U.S. patent application Ser. No. 11/377,630, filed Mar. 16, 2006, to Crooks et al.

Adhesives used to secure tipping materials to each other or to other filtered cigarette components can vary. Typical exemplary adhesive formulations that are used for application of tipping material to other cigarette components in commercial filtered cigarette manufacturing operations are water-based emulsions incorporating mixtures of ethylene vinyl acetate copolymers and polyvinylacetate. Representative adhesives that are useful for applying tipping materials to cigarette components are available as Reference Nos. 32-2049 and 32-2124 from National Starch & Adhesives Corp. See also, for example, Skeist, Handbook of Adhesives, 2^{nd} Edition (1977); Schneberger, Adhesive in Manufacturing (1983); Gutcho, Adhesives Technology Developments Since 1979 (1983); Landrock, Adhesives Technology Handbook (1985); and Flick, Handbook of Adhesives Raw Materials, 2^{nd} Edition (1989).

As-formed cigarettes may be loaded into an appropriately-sized cigarette packaging container. Representative types of cigarette packages suitable for use with the present disclosure include, for example, those of the types set forth in U.S. Pat. No. 4,294,353 to Focke et al.; U.S. Pat. No. 4,534,463 to Bouchard; U.S. Pat. No. 4,715,497 to Focke et al.; U.S. Pat. No. 4,852,734 to Allen et al.; U.S. Pat. No. 5,139,140 to Burrows et al.; U.S. Pat. No. 5,333,729 to Wolfe; U.S. Pat. No. 5,938,018 to Keaveney et al.; U.S. Pat. No. 6,726,006 to Funderburk et al.; U.S. Pat. No. 6,736,261 to Thomas et al.; and U.S. Pat. No. 7,325,382 to Nelson et al.; PCT WO 2005/113386 to Buse; UK Pat. Spec. 1,042,000; German Pat. App. DE 10238906 to Marx; and US Pat. Appl. Nos. 2004/0217023 to Fagg et al.; 2004/0256253 to Henson et al.; 2005/0150786 to Mitten et al.; 2006/0243611 to Wu; 2008/0093234 to Jones et al.; and 2008/0099353 to Parsons et al. In some instances, the cigarette package may be of the type that has been referred to as a “shoulder box.” Representative types of shoulder box packages have been commercially available, and the selection thereof is a matter of choice. If desired, the shoulder box and associated wrapping materials can be embossed, printed with indicia, or the like, particularly during pre-sale production.

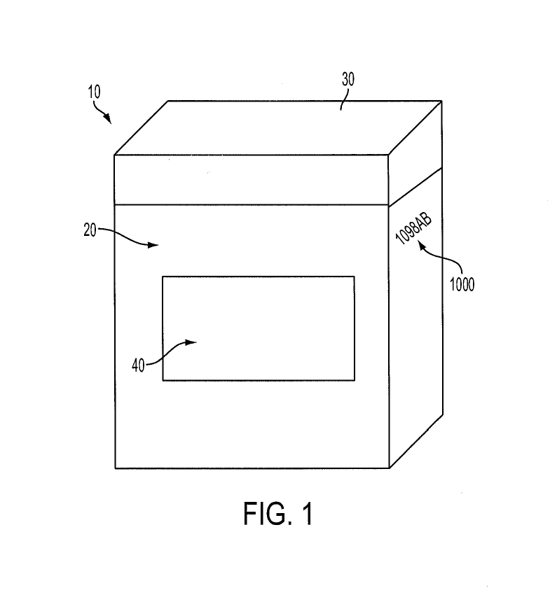

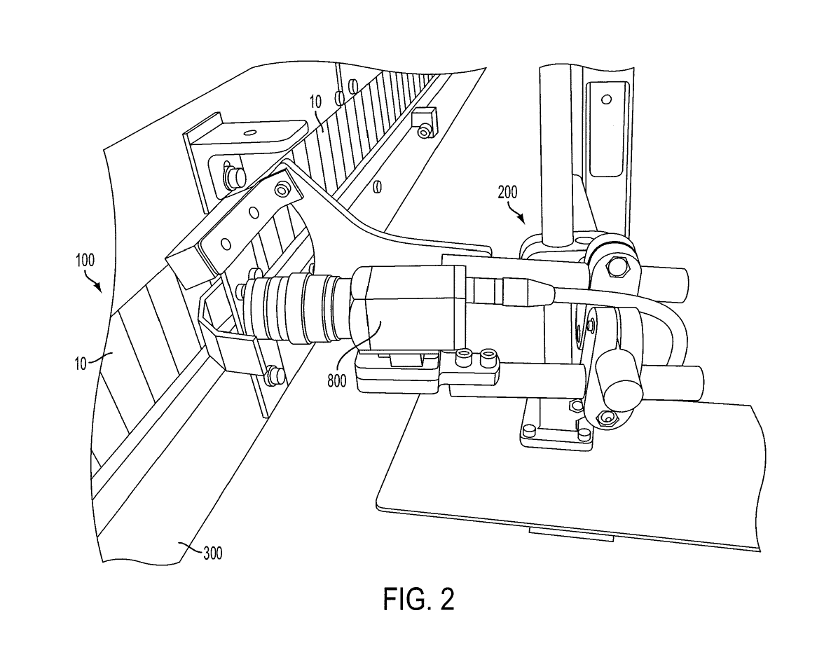

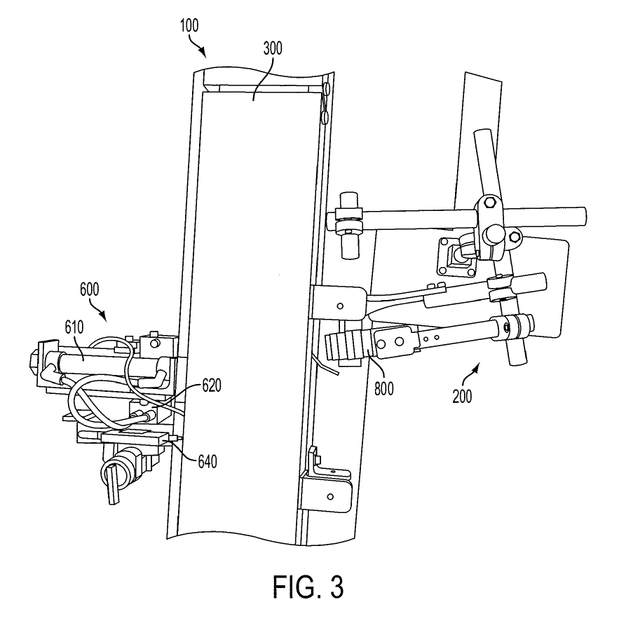

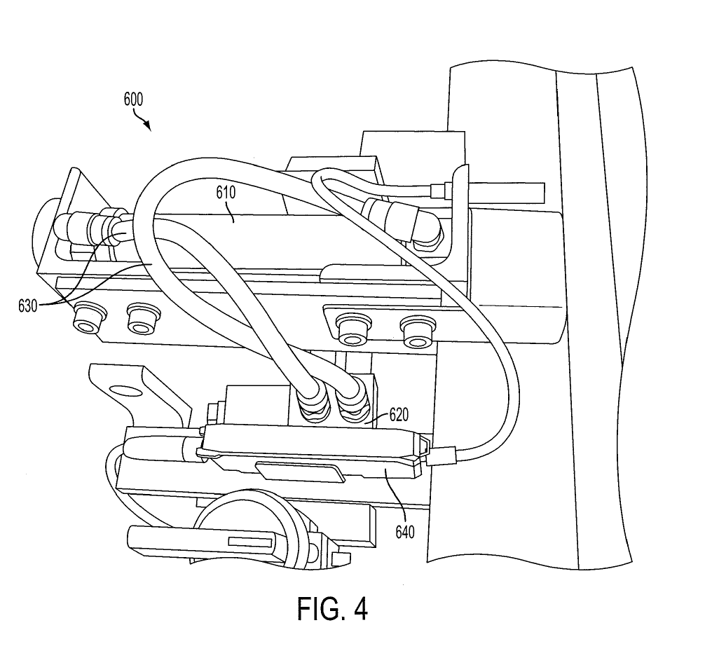

As shown in FIG. 1, a representative cigarette package 10 may include a cigarette receptacle portion 20 for holding cigarettes, and a cover portion 30 associated therewith that is configured to close over the cigarette receptacle portion 20 so as to maintain the cigarettes within the package 10. A representative cigarette package 10 has an inner depth of about 4 mm to about 6 mm; a length of about 19 cm; and a width of about 9 cm. The cigarette package 10 may have outer dimensions of about 8.2 cm wide, about 8.9 cm long and about 18 mm high (such dimensions being measured when the package 10 is in a closed or sealed configuration). The package 10 is shown in a closed position and is configured to contain twenty cigarettes. The cigarettes are contained in the cigarette receptacle portion 20 of the cigarette package 10. The cigarettes are aligned within the package in two rows of ten cigarettes, with one row positioned adjacent to the second row. The cigarette package 10 preferably may be manufactured from folded paperboard material, and can be of any type useful for the packaging of cigarettes. The cigarette package 10 includes a generally rectilinear cover portion 30 that opens with respect to the cigarette receptacle portion 20 about a hinge that extends transversely across the engagement with the cigarette receptacle portion 20. The cover portion 30 can cooperate with the receptacle portion 20 to close over the cigarettes 13, or it can be opened to expose the cigarettes. If desired, the package of cigarettes can be wrapped in a plastic or other film (e.g., a clear polypropylene film).

The cigarettes may be packaged using, for example, the equipment and materials described in U.S. Pat. No. 7,325,382 to Nelson et al., which is incorporated herein by reference in its entirety. That is, a cigarette packaging apparatus may be provided to insert the as-formed cigarettes into a cigarette packaging container such as, for example, the cigarette package 10.

In some instances, the cigarette package 10 can be embossed, printed with indicia, or the like during the original manufacturing process for indicating the manufacturer, brand, flavor etc. of the cigarettes to be contained in the cigarette package 10. Such indicia may be typically pre-printed on the packaging and/or wrapping materials on the production line with an imprinting device configured to interact with the cigarette package 10 for imprinting thereon. That is, the imprinting unit may be configured to interact with at least one of the cover portion 30 and the cigarette receptacle portion 20 of the cigarette package 10, so as to selectively imprint an indicia, such as, for example, an alphanumeric character string and/or a graphical character 40 thereon as shown, for example, in FIG. 1. In some instances, the indicia may be imprinted only on the cover portion 30, only on the cigarette receptacle portion 20, or on both cigarette package portions 20, 30. In some instances, the imprinting unit may include one or more laser or inkjet imprinting units capable of being controlled by a computer device to provide imprinting of the indicia on the cigarette package 10. In some instances, the cigarette package 10 may be rotated and/or flipped so as to facilitate, for example, printing of the indicia by a single imprinting element on the opposing surface and/or sides of the cigarette package 10. The indicia may be formed by the imprinting unit in many different selective manners.

In some instances, the indicia may include an alphanumeric character string forming a date code label 1000 indicative of or related to, for example, the date, location, or other information in which the respective cigarette package was filled with as-finished cigarettes. Such date code labels 1000 may be used for tracking purposes such that each cigarette package can be traced to its packaging date and origin. Typically, the date code label 1000 may consist of a string of alphanumeric characters, which comprise alphabetic letters, words, numbers, or combinations thereof. However, the date code label 1000 could also be provided as, for example, a bar code label capable of providing information related to the date, location, etc. of the packaging date and location.

The indicia imprinted on the cigarette package 10 may be affected by various parameters associated with the operation of the imprinting unit. For example, print resolution may be controlled by:
a) Character width and height: For a single line of print, a character dimension of about 3 mm wide and about 4 mm high may be required. For two lines of print, a character dimension of about 1.5 mm wide and about 2.5 mm high may be required. For three lines of print, a character dimension of about 1.5 mm wide and about 2.0 mm high may be required.
b) Character font and weight: Representative fonts include 3-LS Arial, 2-LS Arial, Comic Sans MS, Times New Roman, or any other suitable font.
c) Character weight may be controlled by the use of the bold print selection. Adjustments may also be made in the laser power and laser beam duration settings, and such parameters may also affect the appearance of the printed character.

The number of characters that may be included on each line of message may be controlled, for example, by:
d) The dimension of the portion of the cigarette package 10 being imprinted. For instance, the length or width of the cigarette package 10 may be the limiting factor.
e) The particular font and character weight used for the customization. As the values of such parameters increase, the total number of characters capable of being used decreases.

However, in the imprinting of the indicia (e.g., date code labels 1000), the procedure for imprinting on the cigarette package may result in certain undesirable defects which leave the indicia illegible such that the cigarette package can not be properly traced to, for example, its packaging date or packaging location. For example, the date code label may be partially or entirely missing from the cigarette package, the date code label may be compressed or otherwise smudged such that the date code label is rendered illegible, and the date code label may include some other characteristic affecting the readability thereof.

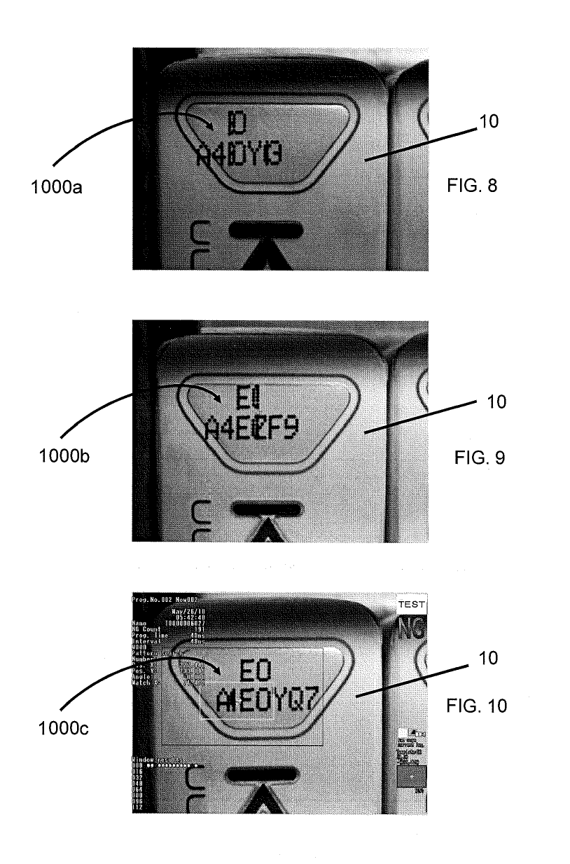

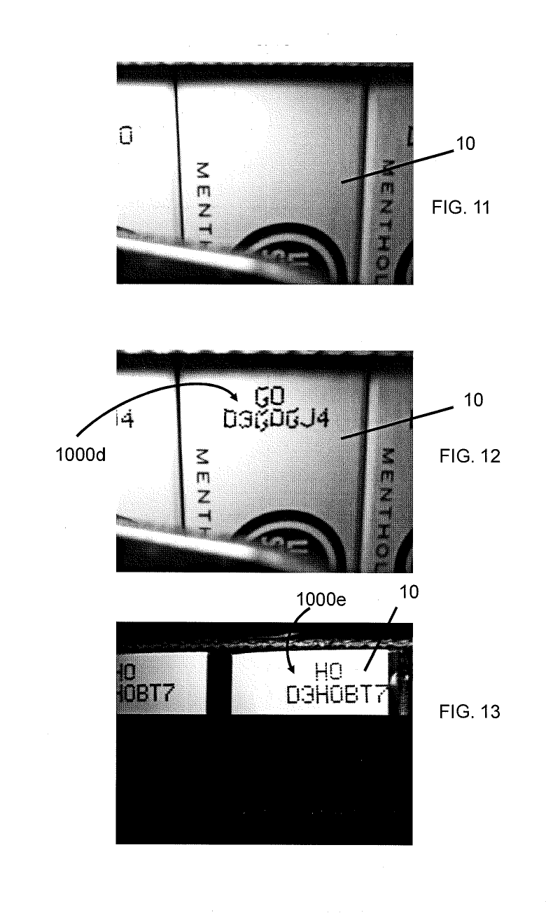

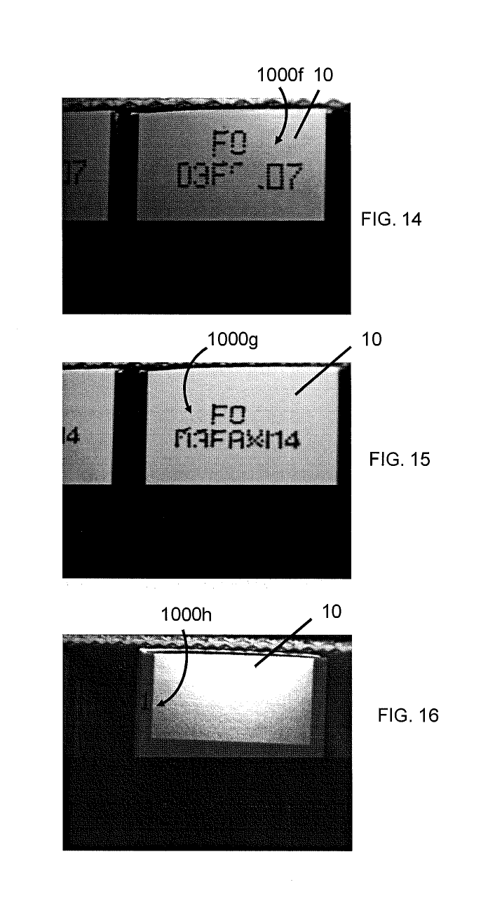

As such, upon cigarettes being packaged into the cigarette package 10, an opportunity may be present to examine the cigarette package 10 for any apparent defects, such as, for example, defects associated with the date code label 1000. Such defects may be those that render the date code label 1000 visibly unreadable, non-comprehensible, or otherwise illegible to a person. That is, the date code label 1000 would be of such character that it could not be read for identifying the information associated with the respective cigarette package 10. Some such apparent defects may include, for example, the date code label 1000 may be partially or entirely missing from the cigarette package (FIGS. 11 and 13-16), the date code label 1000 may be compressed, distorted, or otherwise smudged such that the date code label is rendered illegible (FIGS. 8-10 and 12), and the date code label 1000 may include some other characteristic affecting the readability thereof.

In this regard, there may be provided an apparatus and method for evaluating a cigarette package for defects, and particularly for evaluating the indicia imprinted on a cigarette package for defects. While the cigarette package defects described herein relate to imprinted indicia defects, it is understood that the apparatuses and methods of the present disclosure may be used for detecting other defects of the cigarette package, including damaged packaging or other indicia defects not related to the date code label 1000. Instead, the present disclosure may be applied to any feature of the cigarette packaging in which a visible inspection may be useful, including providing visible comparative analysis. As such, a cigarette package may be considered defective based on many different factors regarding the cigarette package, including various appearance factors, and is not limited to the detection of a defective date code label 1000.

In any instance, in one aspect of the present disclosure, an inspection device, such as an imaging device 800 may be operably engaged with a transport device 100 and configured to optically inspect each cigarette package 10 at least about a visible portion of the cigarette package 10 as the cigarette package is transported through an inspection position as the cigarette package 10 is directed in a machine direction. That is, at least a portion of the cigarette package 10 may exposed with respect to the transport device 100 such that the imaging device 800 is capable of viewing the portion of the cigarette package 10 having the date code label imprinted thereon or other indicia to be inspected.

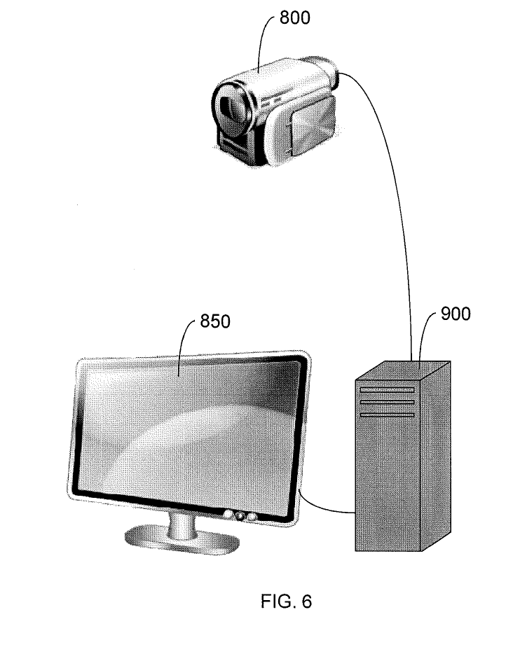

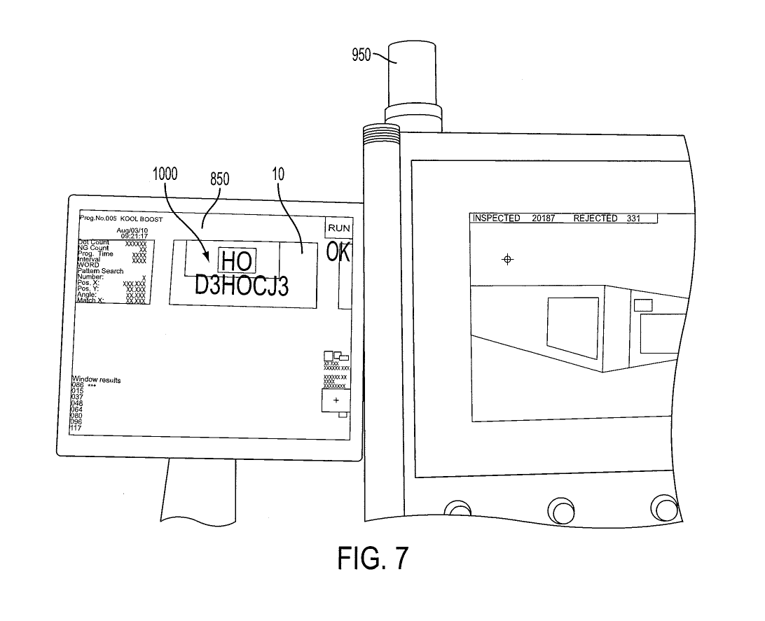

More particularly, one or more imaging devices 800 may be disposed adjacent to the transport device 100, with each imaging device 800 being configured to capture one or more images of each cigarette package 10 as the cigarette packages are transported through an inspection position (i.e., within the viewing scope of the imaging device) in the machine direction. In such instances, the imaging device 800 may be disposed adjacent to the transport device 100 and be configured to be capable of capturing one or more images of the portion of the cigarette package 10 having the date code label imprinted thereon (or, in the case of a missing date code label, where the date code label 1000 is supposed to be imprinted on the cigarette package 10). That is, when a cigarette package is secured by the transport device 100, at least a portion of the cigarette package 10 will be visible externally to the transport device 100. In some instances, as shown in FIGS. 6 and 7, a display terminal 850 may be operably engaged with the imaging device 800 of the inspection device, wherein the display terminal 850 may be configured to display the at least one image of each cigarette package 10.

In other aspects of the disclosure, the cigarette package 10 may be supported in different manners so as to allow the inspection device to perform the optical inspection thereof. For example, the cigarette package 10 may be supported by, or independently of, the transport device 100. In some such instances, the cigarette package 10 may be supported by engagement with one or both ends of the cigarette package 10. In still other aspects, the cigarette package 10 may be supported such that the imaging device 800 moves about the cigarette package 10 to perform the optical inspection thereof. The cigarette packages 10 may be oriented in any manner for transportation along the transport device 100. In this regard, the imaging device 800 may be oriented along the transport device 100 in an adjacent manner such that the imaging device 800 has a line-of-sight to the visibly exposed/accessible portion of the cigarette package 10 having the date code label imprinted thereon. The inspection device may be mounted to the transport device 100 via a mounting system 200. In other instances, the inspection device may be mounted discretely/separately from and adjacent to the transport device 100 using the mounting system 200. According to some aspects, the transport device 100 may include a conveyor device 300 configured to feed the cigarette packages 10 in the desired orientation and direction to the inspection position, and then onto the next manufacturing stage such as, for example, a wrapping stage in which each cigarette package is wrapped in cellophane. The conveyor device 300 may be operably engaged with a hopper or other processing equipment for receiving as-filled cigarette packages 10. In some instances, the release of the cigarette packages 10 can be indexed onto the conveyor device 300 under control of, for example, a computer device.

In one aspect, in addition to the display terminal 850 as shown in FIG. 6, the inspection device may further comprise a computer device 900 configured to automatically process the at least one image from the imaging device(s) 800 to determine whether the inspected cigarette package is defective. More particularly, in some instances, the inspection device may comprise or include, for example, a high speed monochrome (or color) camera (Model No. CV-H035C), a monitor (e.g., a VGA monitor), a PLC (Model No. KV-16AT), and a high speed vision system (Model No. CV-5502npn), all from Keyence Corporation. In one configuration, the inspection system may be implemented to perform a “machine vision” analysis of the cigarette packages 10 with an inspection speed (i.e., processing time per cigarette package inspection) of less than about 100 milliseconds, and preferably less than about 50 milliseconds. That is, the computer device 900, such as the vision system, may be configured to analyze the one or more images of the area of the cigarette package 10 having the date code label 1000 imprinted thereon to determine whether any defects exist in the readability of the date code label 1000. In some instances, the inspection device may be capable of inspecting between about 400 to about 500 cigarette packages per minute.

For example, the computer device 900 may be programmed or otherwise include a database with examples of various defects which may occur during the imprinting of the date code label on the cigarette package 10. In those instances, the one or more images captured by the imaging device 800 can then be compared to the exemplary defects by the computer device 900. As such, if the computer device 900 matches the one or more images of a particular cigarette package to one of the exemplary defects, to a reasonable certainty, then the particular cigarette package may be determined to be defective. In another example, the computer device 900 may be programmed with one or more examples of non-defective cigarette packages. In those instances, the one or more images of the cigarette package being inspected may then be compared to the non-defective examples by the computer device 900. As such, if the computer device 900 does not match the one or more images of a particular cigarette package to one of the non-defective examples, to a reasonable certainty, then the particular cigarette package may be determined to be defective. One skilled in the art, however, will appreciate that a “machine vision” inspection or other automated evaluation of the one or more images of the cigarette package may be accomplished in many different manners and, as such, the examples presented herein are not intended to be limiting. The computer device 900 may be capable of performing an optical character recognition (OCR) analysis/evaluation on the one or more images captured by the imaging device 800. In this regard, when the date code label 1000 comprises a string of alphanumeric characters, the computer device 900 can evaluate the legibility of the date code label 1000 imprinted on the cigarette package 10. In some instances, the computer device 900 may be capable of comparing the OCR inspected date code label 1000 to a database with known/actual date code labels 1000 to determine if a match is present. Further, the computer device 900 may be configured to identify a cigarette package as defective when the imaging device 800 is incapable or otherwise unable to read the date code label 1000 after completion of the OCR imaging analysis. That is, in some instances, the computer device 900 may recognize that the date code label 1000 is either illegible or missing.

As a result of the disclosed optical inspection/machine vision/OCR evaluation of the cigarette package 10, aspects of the disclosed cigarette package inspection system may be capable of particularly determining and/or identifying, from the optical inspection thereof, certain apparent defects in the date code labels 1000 imprinted on the cigarette packages such as, for example, date code labels 1000a-1000h which are partially or entirely missing from the cigarette package (FIGS. 11 and 14-16), date code labels which are misaligned (FIG. 13), date code labels 1000 which are compressed, distorted, or otherwise smudged such that the date code label is rendered illegible (FIGS. 8-10 and 12), and date code labels 1000 which include some other characteristic(s) affecting the readability thereof.

In some aspects, a defective cigarette package 10, identified as such by the cigarette package inspection system, may be removed from the process prior to that defective cigarette package being packaged for further distribution. As previously disclosed, such a defective cigarette package may not necessarily be secured to the transport device 100. As such, the defective cigarette package 10 may be removed from the transport device 100 at an appropriate point as the transport device 100 advances that defective cigarette package from or past the inspection position. For example, the defective cigarette package may be deposited in a reject receptacle 500, or directed to a re-printing process, depending on the particular defect identified. In other instances, the defective cigarette package may be removed from the transport device 100 by a selection device 600 operably engaged therewith. In some aspects, directing the defective cigarette package in a desired manner to a subsequent process for handling such defective cigarette packages may be accomplished in response to the computer device 900 associated with the inspection device. For example, the selection device 600 may be in communication with the computer device 900 such that, upon identifying a defective cigarette package, the computer device 900 directs the selection device 600 to remove the defective cigarette package from the transport device 100.

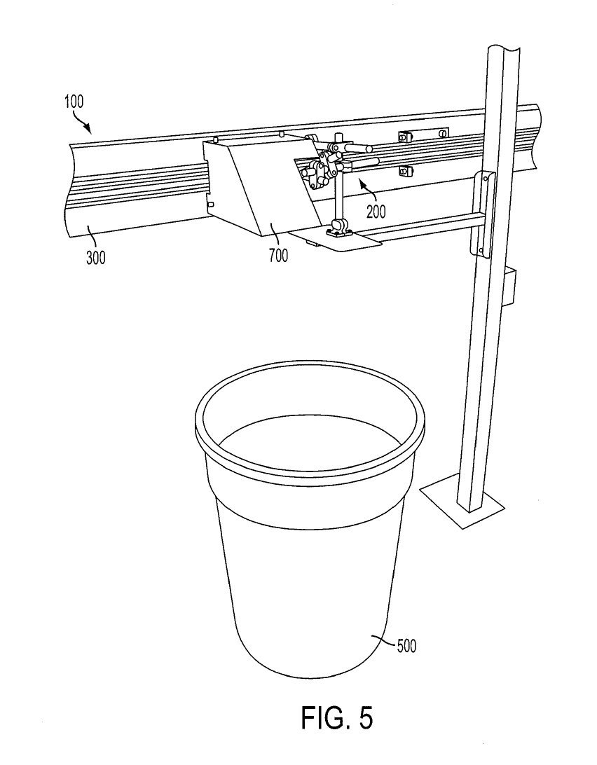

According to one aspect, the selection device 600 may include a plunger device 610 controlled by a solenoid valve 620. A switching device may be used to operate the plunger device 610, in which the switching device controls the air flow for moving the plunger device 610. Appropriate air lines 630 may be provided for operating the plunger device 610. The plunger device 610, when actuated as directed by the computer 900, extends into the transport device 100 so as to interact with the defective cigarette package 10, thereby removing the defective cigarette package 10 from the transport device 100. A sensor device 640 may be provided for ensuring proper actuation timing of the plunger device 610 such that the defective cigarette package 10 is appropriately removed from the transport device 100, rather than a non-defective cigarette package 10 being removed. In some instances, a cover member 700 may be mounted or otherwise provided on the transport device 100 opposite the selection device 600. The cover member 700 may be implemented to direct defective cigarette packages into the reject receptacle 500. Furthermore, the cover member 700 may provide cover and/or protection to the imaging device 800, as shown in FIG. 5, or otherwise provide appropriate lighting for optimal operation of the imaging device 800. In addition, the cover member 700 may provide protection to personnel working about the selection device 600.

In addition, aspects of the cigarette package inspection system may be configured to monitor the determined defects found in the cigarette packages, for example, by amount and/or frequency, and communicating the results or otherwise directing appropriate corrective action be taken, if a selected threshold is attained (i.e., whether to address an upstream process or to address a printing issue). For example, an indicia may be displayed on the display terminal 850 to alert an operator monitoring the display terminal 850 that a first pre-determined threshold of defective cigarette packages 10 has been met. The displayed indicia may be a graphical icon, alphanumeric text, a color indicia, etc. Furthermore, in instances where a second pre-determined threshold has been met (i.e., indicating a more extensive issue in regard to the quantity of defective cigarette packages identified over a pre-determined duration of time), a supplemental indicia may be supplied to the operator to potentially indicate that the transport device should be shut down so as to allow the source of the defects to be identified. For example, a flashing light 950 (FIG. 7) may be provided to signal to the operator that immediate attention is required.

Many modifications and other aspects of the disclosure will come to mind to one skilled in the art to which this disclosure pertains having the benefit of the teachings presented in the foregoing description; and it will be apparent to those skilled in the art that variations and modifications of the present disclosure can be made without departing from the scope or spirit of the disclosure. For example, the concept of applying an optical inspection/machine vision/OCR evaluation to a cigarette package may also be extended to other containers for storing tobacco-related products (including smokeless tobacco products) required to have a date code label imprinted thereon for tracking purposes. That is, the disclosure provided herein is not intended to be limited to the inspection of cigarette packages containing cigarettes, and instead includes instances in which a tracking label or other identifying information imprinted or otherwise positioned on a tobacco-related product container. Further, in some aspects, the one or more images captured by imaging device 800 may be concurrently analyzed by the computer device 900 to evaluate other parameters of the cigarette package such as, for example, the inclusion of other indicia imprinted on the cigarette package. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for purposes of limitation.

That which is claimed:

1. A cigarette package inspection system, comprising:
a transport device configured to transport individual cigarette packages to an inspection position such that at least a portion of the cigarette package is visibly accessible for optical inspection; and
an inspection device operably engaged with the transport device and configured to optically inspect each cigarette package, at least about the visibly accessible portion thereof, as the cigarette package is transported through the inspection position, the inspection device being configured to automatically determine from the optical inspection whether the inspected cigarette package is defective.

2. A system according to claim 1, wherein the inspection device comprises an imaging device configured to capture at least one image of each cigarette package, at least about the accessible portion of the cigarette package, as the cigarette package is transported through the inspection position.

3. A system according to claim 2, further comprising a display terminal operably engaged with the imaging device and configured to display the at least one image of each cigarette package.

4. A system according to claim 2, wherein the inspection device further comprises a computer device configured to automatically process the at least one image from the imaging device to determine whether the inspected cigarette package is defective.

5. A system according to claim 4, wherein the imaging device and the computer device are configured to employ optical character recognition (OCR) for determining whether the inspected cigarette package is defective.

6. A system according to claim 1, further comprising a selection device operably engaged with the transport device, the selection device being responsive to the inspection device to remove any cigarette package determined to be defective by the inspection device.

7. A system according to claim 6, wherein the selection device comprises a plunger device configured to engage any cigarette package determined to be defective by the inspection device so as to remove the defective cigarette package from the transport device.

8. A system according to claim 1, wherein the inspection device is further configured to determine whether a code label defect exists in a code label imprinted on the cigarette package from the optical inspection thereof, the code label comprising at least one alphanumeric character selectively imprinted on the cigarette package, the code label defect being determined according to whether the code label is at least partially missing, whether the code label is visibly legible, whether the code label is missing a character, and whether the code label includes a characteristic affecting the readability thereof.

9. A system according to claim 1, wherein the transport device is configured to engage an end portion of the cigarette package such that the cigarette package is supported by at least the end portion during transportation through the inspection position, and wherein the cigarette packages are received on the transport device in serial abutting alignment.

10. A system according to claim 1, wherein the transport device comprises a conveyor device configured to feed the cigarette packages to the inspection position along a transport direction.

11. A method of inspecting a cigarette package, said method comprising:
transporting individual cigarette packages to an inspection position with a transport device such that at least a portion of the cigarette package is visibly accessible for optical inspection;
optically inspecting each cigarette package with an inspection device, at least about the visibly accessible portion of the cigarette package, as the cigarette package is transported through the inspection position; and
automatically determining whether the inspected cigarette package is defective based on the optical inspection thereof.

12. A method according to claim 11, wherein optically inspecting each cigarette package with an inspection device further comprises capturing at least one image of each cigarette package with an imaging device, at least about the visibly accessible portion thereof, as the cigarette package is transported through the inspection position.

13. A method according to claim 12, further comprising displaying the at least one image of each cigarette package on a display terminal operably engaged with the imaging device.

14. A method according to claim 12, wherein automatically determining whether the inspected cigarette package is defective further comprising automatically processing the at least one image from the imaging device with a computer device to determine whether the inspected cigarette package is defective.

15. A method according to claim 14, wherein the imaging device and the computer device employ optical character recognition (OCR) for determining whether the inspected cigarette package is defective.

16. A method according to claim 11, further comprising removing any cigarette package determined to be defective with a selection device operably engaged with the transport device, in response to the determination thereof by the inspection device.

17. A method according to claim 16, wherein the selection device comprises a plunger device configured to engage any cigarette package determined to be defective by the inspection device.

18. A method according to claim 11, wherein said determining step comprises determining whether a code label defect exists in a code label imprinted on the cigarette package, the code label comprising at least one alphanumeric character selectively imprinted on the cigarette package, the code label defect being determined according to whether the code label is at least partially missing, whether the code label is visibly legible, whether the code label is missing a character, and whether the code label includes a characteristic affecting the readability thereof.

19. A method according to claim 11, further comprising engaging an end portion of the cigarette package with the transport device such that the cigarette package is supported by at least the end portion during transportation through the inspection position, and wherein the cigarette packages are received on the transport device in serial abutting alignment.

20. A method according to claim 11 wherein transporting the cigarette package further comprises transporting the cigarette package with a conveyor device along a transport direction toward the inspection position.
